(19) United States
(12) Patent Application Publication
(10) Pub. No.: US 2008/0312967 A1
(43) Pub. Date: Dec. 18, 2008

(54) COMPREHENSIVE METHOD AND SYSTEM FOR INTAKE SCREENING AND MEDICAL RECORDS MANAGEMENT

(75) Inventors: Jennifer Piper, Nolensville, TN (US); Eric Thrailkill, Nashville, TN (US); Mark Wisniewski, Brentwood, TN (US)

Correspondence Address: ARENT FOX LLP, 1050 CONNECTICUT AVENUE, N.W., SUITE 400, WASHINGTON, DC, 20036, US

(73) Assignee: AMERICA SERVICE GROUP, INC., Brentwood, TN (US)

(21) Appl. No.: 12/130,604

(22) Filed: May 30, 2008

Related U.S. Application Data
(60) Provisional application No. 60/924,791, filed on May 31, 2007.
(60) Provisional application No. 60/924,792, filed on May 31, 2007.

(51) Int. Cl. G06Q 50/00

(52) U.S. Cl. 705/3

(57) ABSTRACT

A system and method for providing health care services, such as medical intake screening and follow-up patient care, including management of medical records and access to patient information for incarcerated individuals. Data regarding medical information collected during an initial intake and screening process and subsequent physical examination may be inputted into a data repository. Triggers based upon the specific data entered may generate alerts for follow up medical care.

### CROSS-REFERENCE TO RELATED APPLICATIONS

This application claims priority the following of Applicants' co-pending applications:

U.S. Provisional Application No. 60/924,792, titled “Method and System for Intake Screening and Medical Records Management,” filed on May 31, 2007; and

U.S. Provisional Application No. 60/924,791, titled “Comprehensive Method and System for Intake Screening and Medical Records Management,” filed on May 31, 2007, each of which is incorporated by reference herein in its entirety.

### BACKGROUND OF THE INVENTION

1. Field of the Invention

The present invention relates to methods and systems for providing health care services, such as medical intake screening and follow-up patient care, including management of medical records and access to patient information during subsequent screening. Specifically, the present invention is directed to providing intake screening and medical records management for incarcerated individuals located at various sites.

2. Description of Related Art

One problem that exists in the art today is that the initial intake screenings of incarcerated individuals, which are performed by a variety of clinical personnel, have a high variation in the clinical procedures used, the timing of the intake, and the clinical skill of the personnel performing the intake, among other factors. In addition, many facilities use paper-based, primarily manual systems to perform the intake procedures. This approach often leads to difficulties with subsequent patient treatment, and particularly with providing accurate and up-to-date health information to medical practitioners at the point of care, to ensure appropriate and timely follow-up health care services, if needed.

There is a need in the art, therefore, for a method and system that provides streamlined uniform initial medical intake screening and follow-up patient care procedures, with little or no variation in the clinical procedures used, the timing of the intake, and the clinical skill of the personnel performing the intake. In addition, there is a need for a method and system for medical intake screening and follow-up patient care, based on secure electronic storage of information, which would ensure timely and secure access to patient information, both during the intake process and for subsequent patient treatment.

The National Commission for Correctional Health Care (NCCHC) and the American Correctional Association (ACA) are two governing bodies that provide procedures and recommendations for health care services for incarcerated individuals. Thus, there is a need in the art, for a method and system that provides streamlined uniform initial medical intake screening and follow-up medical treatment in the context of the guidelines and recommendations for health care services for incarcerated individuals.

### SUMMARY OF THE INVENTION

The present invention solves the above-identified needs, and others, by providing methods and systems that include streamlined uniform initial medical intake screening and follow-up patient care procedures, with little or no variation in the clinical procedures used, the timing of the intake, and the clinical skill of the personnel performing the intake. In addition, the present invention provides methods and systems for medical intake screening and follow-up patient care, based on secure electronic storage of information, to ensure timely and secure access to patient information, both during the intake process and for any subsequent patient treatment. Further, the present invention provides methods and systems in accordance with the guidelines and recommendations for health care services for incarcerated individuals.

In one exemplary aspect, the present invention is based on an open system architecture, comprising an Administrative Unit, a Patient Search Unit, an Intake Screening Unit, a History and Physical Examination Unit, an Automated Patient Summary Unit, and a Forms and Reports Unit.

The Administrative Unit serves to manage contract information, pick lists, user information, and role security. The Patient Search Unit facilitates locating patient health records (currently admitted or previously discharged). The Intake Screening Unit facilitates electronic documentation of the initial intake examination. The History and Physical Examination Unit facilitates complete documentation of the history/physical examinations. The Automated Patient Summary Unit provides a summary of current patient clinical problems, allergies, medications, and appointments. The Forms and Reports Unit provides a uniform system of forms and reports for use by the system, e.g., clinical and scheduling forms and reports for inclusion in the medical record.

In an aspect of the present invention, after an individual is brought to the healthcare personnel, an initial intake and screening of medical information may be performed for the individual. During the initial intake and screening process, an individual may be assessed for any immediate health concerns that may need expedited medical attention. If the individual needs immediate medical attention, the intake screening process can be stopped and the appropriate medical treatment may be administered. The intake process may be completed after the individual has received the appropriate medical treatment. If the individual does not need immediate medical attention, the intake process continues. Specific data regarding the medical information collected during the initial intake and screening process may be inputted into a centralized data repository. Triggers based upon the specific data entered may generate alerts for follow up activities. These alerts may ensure consistent follow up activities and may help guide a physician through a clinical examination.

Next, the individual may undergo a history and physical examination. The history and physical examination may be conducted seven to fourteen days, for example, after the initial intake and screening process and may include more in depth questions regarding the individual's medical history. Specific data may be entered into a data repository in response to questions asked during the history and physical examination. It may be possible to create triggers based upon the specific data entered to generate alerts for follow up activities.

A comprehensive diagnosis for the individual may be provided after the initial intake and screening process and the history and physical examination are completed. The comprehensive information may include a problem list, allergies, upcoming appointments and current medications, among others.

Once the information regarding an individual has been entered, the user may search for an individual based upon a unique identification number. This identification number may include a state ID number, a booking number or any other number that might uniquely identify the individual. The user may create and print reports based upon parameters the user specifies.

Additional advantages and novel features of these aspects of the invention will be set forth in part in the description that follows, and in part will become more apparent to those skilled in the art upon examination of the following or upon learning by practice of the invention.

### BRIEF DESCRIPTION OF THE DRAWINGS

Various exemplary aspects of the systems and methods will be described in detail, with reference to the following figures, wherein:

FIG. 1 presents an exemplary system diagram of various hardware components and other features, for use in accordance with an aspect of the present invention;

FIG. 2 is a block diagram of various exemplary system components, in accordance with an aspect of the present invention;

FIG. 3 presents an example flow diagram of functions performed in accordance with aspects of the present invention;

FIG. 4 is an example of performing intake in accordance with one aspect of the present invention;

FIG. 5 is an example of generating alerts in accordance with one aspect of the present invention;

FIG. 6 is an example of performing a history and physical examination in accordance with one aspect of the present invention;

FIG. 7 is an example of providing comprehensive diagnosis in accordance with an aspect of the present invention;

FIG. 8 is an example of searching for an individual in accordance with an aspect of the present invention; and

FIG. 9 presents an example flow diagram of functions performed in accordance with aspects of the present invention.

### DETAILED DESCRIPTION OF ASPECTS OF THE PRESENT INVENTION

These and other features and advantages of this invention are described in, or are apparent from, the following detailed description of various exemplary aspects of the present inventions.

The present invention may be implemented using a centralized data repository which can be accessed through a web-based interface that allows the user to access data regarding an individual's health care. Storing the information centrally may allow for easy retrieval of the information from any facility that has broadband Internet or other means of access. Additionally, implementing changes in code, upgrading the system, having ability to benchmark facilities, and various system supports may be performed easier using a centralized data repository.

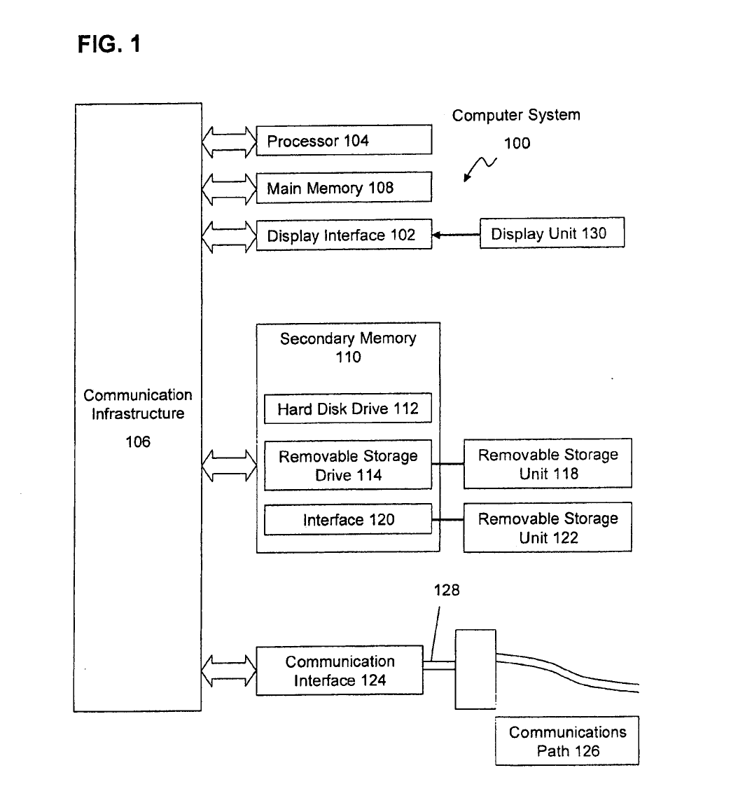

The present invention may be implemented using hardware, software, or a combination thereof and may be implemented in one or more computer systems or other processing systems. In one aspect, the invention is directed toward one or more computer systems capable of carrying out the functionality described herein. An example of such a computer system 100 is shown in FIG. 1.

Computer system 100 includes one or more processors, such as processor 104. The processor 104 is connected to a communication infrastructure 106 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 100 can include a display interface 102 that forwards graphics, text, and other data from the communication infrastructure 106 (or from a frame buffer not shown) for display on a display unit 130. Computer system 100 also includes a main memory 108, preferably random access memory (RAM), and may also include a secondary memory 110. The secondary memory 110 may include, for example, a hard disk drive 112 and/or a removable storage drive 114, representing a floppy disk drive, a magnetic tape drive, an optical disk drive, etc. The removable storage drive 114 reads from and/or writes to a removable storage unit 118 in a well-known manner. Removable storage unit 118, represents a floppy disk, magnetic tape, optical disk, etc., which is read by and written to removable storage drive 114. As will be appreciated, the removable storage unit 118 includes a computer usable storage medium having stored therein computer software and/or data.

In alternative aspects, secondary memory 110 may include other similar devices for allowing computer programs or other instructions to be loaded into computer system 100. Such devices may include, for example, a removable storage unit 122 and an interface 120. Examples of such may include a program cartridge and cartridge interface (such as that found in video game devices), a removable memory chip (such as an erasable programmable read only memory (EPROM), or programmable read only memory (PROM)) and associated socket, and other removable storage units 122 and interfaces 120, which allow software and data to be transferred from the removable storage unit 122 to computer system 100.

Computer system 100 may also include a communications interface 124. Communications interface 124 allows software and data to be transferred between computer system 100 and external devices. Examples of communications interface 124 may include a modem, a network interface (such as an Ethernet card), a communications port, a Personal Computer Memory Card International Association (PCMCIA) slot and card, etc. Software and data transferred via communications interface 124 are in the form of signals 128, which may be electronic, electromagnetic, optical or other signals capable of being received by communications interface 124. These signals 128 are provided to communications interface 124 via a communications path (e.g., channel) 126. This path 126 carries signals 128 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 114, a hard disk installed in hard disk drive 112, and signals 128. These computer program products provide software to the computer system 100. The invention is directed to such computer program products.

Computer programs (also referred to as computer control logic) are stored in main memory 108 and/or secondary memory 110. Computer programs may also be received via communications interface 124. Such computer programs, when executed, enable the computer system 100 to perform the features of the present invention, as discussed herein. In particular, the computer programs, when executed, enable the processor 110 to perform the features of the present invention. Accordingly, such computer programs represent controllers of the computer system 100.

In an aspect where the invention is implemented using software, the software may be stored in a computer program product and loaded into computer system 100 using removable storage drive 114, hard drive 112, or communications interface 120. The control logic (software), when executed by the processor 104, causes the processor 104 to perform the functions of the invention as described herein. In another aspect, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect, the invention is implemented using a combination of both hardware and software.

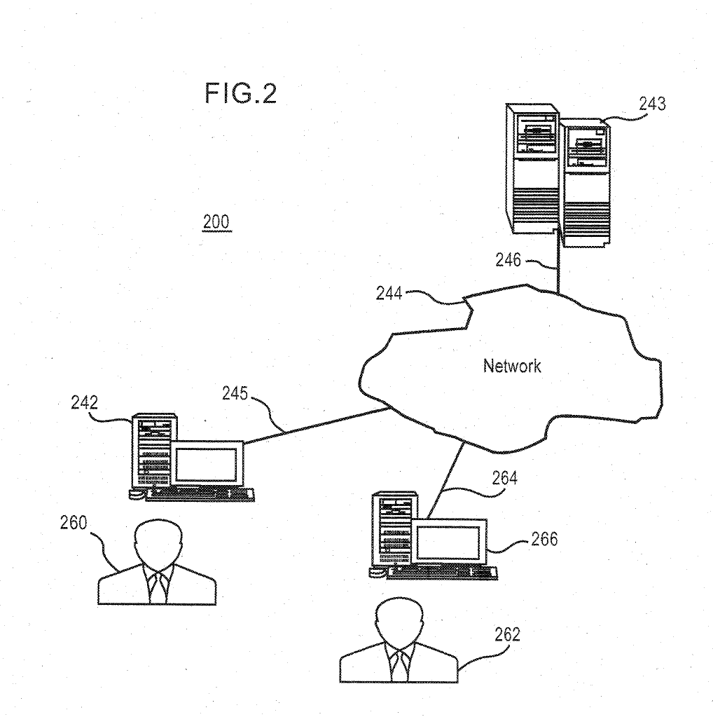

FIG. 2 shows a communication system 200 usable in accordance with the present invention. The communication system 200 includes one or more assessors 260, 262 (also referred to interchangeably herein as one or more “users”) and one or more terminals 242, 266. In one aspect, data for use in accordance with the present invention is, for example, input and/or accessed by assessors 260, 264 via terminals 242, 266, such as personal computers (PCs), minicomputers, mainframe computers, microcomputers, telephonic devices, or wireless devices, such as personal digital assistants (“PDAs”) or a hand-held wireless devices coupled to a server 243, such as a PC, minicomputer, mainframe computer, microcomputer, or other device having a processor and a repository for data and/or connection to a repository for data, via, for example, a network 244, such as the Internet or an intranet, and couplings 245, 246, 264. The couplings 245, 246, 264 include, for example, wired, wireless, or fiberoptic links. In another aspect, the method and system of the present invention operate in a stand-alone environment, such as on a single terminal.

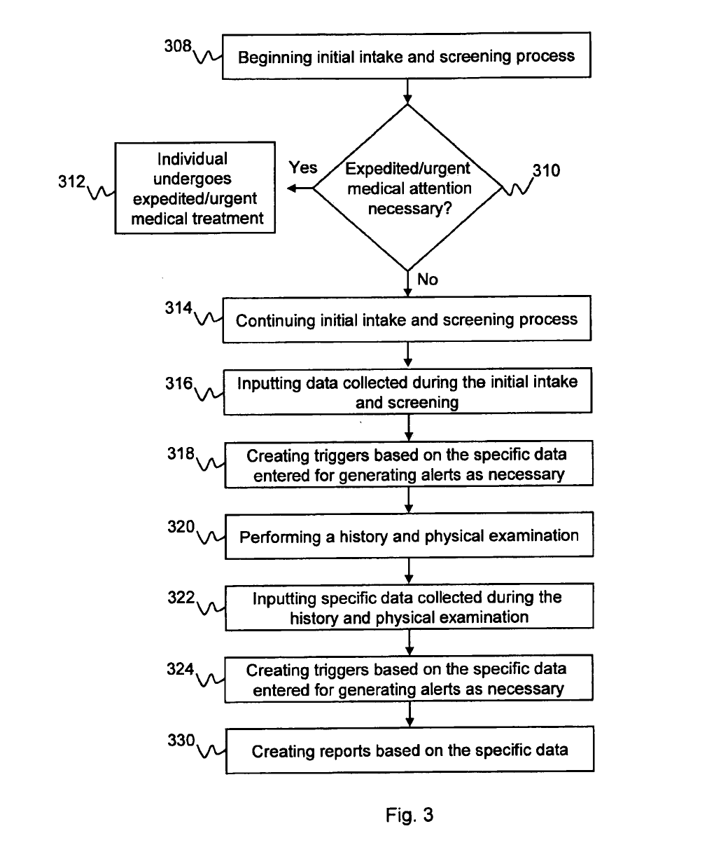

An example flow diagram 300 of functions performed in accordance with an aspect of the present invention will now be described in conjunction with FIG. 3. Once an individual has been sentenced by the court, transferred from another facility, or otherwise incarcerated, the individual may be brought to the healthcare personnel at the facility.

After being brought to the healthcare personnel, an initial intake and screening of medical information may be performed for the individual 308. During the initial intake and screening process, an individual may be assessed for any immediate health concerns that may need expedited medical attention 310. If the individual needs immediate medical attention, the intake screening process can be stopped and the appropriate medical treatment may be administered to the individual 312. After the individual has received the medical treatment, the initial intake process may be completed. If the individual does not need immediate medical attention, the intake process can continue until completed 314.

Specific data regarding the medical information collected during the initial intake and screening process may be inputted into a data repository 316 and may be correlated with a unique identifier for the incarcerated individual. Entering in specific discrete data in response to specific questions can provide a consistent intake and screening process. Further, it may be possible to create triggers based upon the specific data entered to generate alerts for follow-up and other activities 318. These alerts may ensure consistent follow-up activities and may help guide a physician through a clinical examination.

The individual may undergo a history and physical examination 320 seven to fourteen days after the initial intake and screening process. The history and physical examination may include more in depth questions regarding the individual's medical history. Specific data may be entered into a data repository in response to questions asked during the history and physical examination 322, again correlated with the unique identifier for the incarcerated individual. In addition, it may be possible to create triggers based upon the specific data entered to generate alerts for follow up activities 324. These alerts may ensure consistent follow up activities and may help guide a physician through a clinical examination.

A comprehensive medical history and/or diagnosis for the individual may be provided after the initial intake and screening process and after the history and physical examinations are completed. For example, an automatic patient summary may provide comprehensive information regarding the individual. The information may include a problem list, allergies, upcoming appointments and current medications, among others.

Once information regarding an individual has been entered, the user may search for an individual based upon a unique identifier or identification number. This identification number may include a state ID number, a booking number or any other number that might uniquely identify the individual. Additionally, the user may create and print reports based upon specified parameters 330.

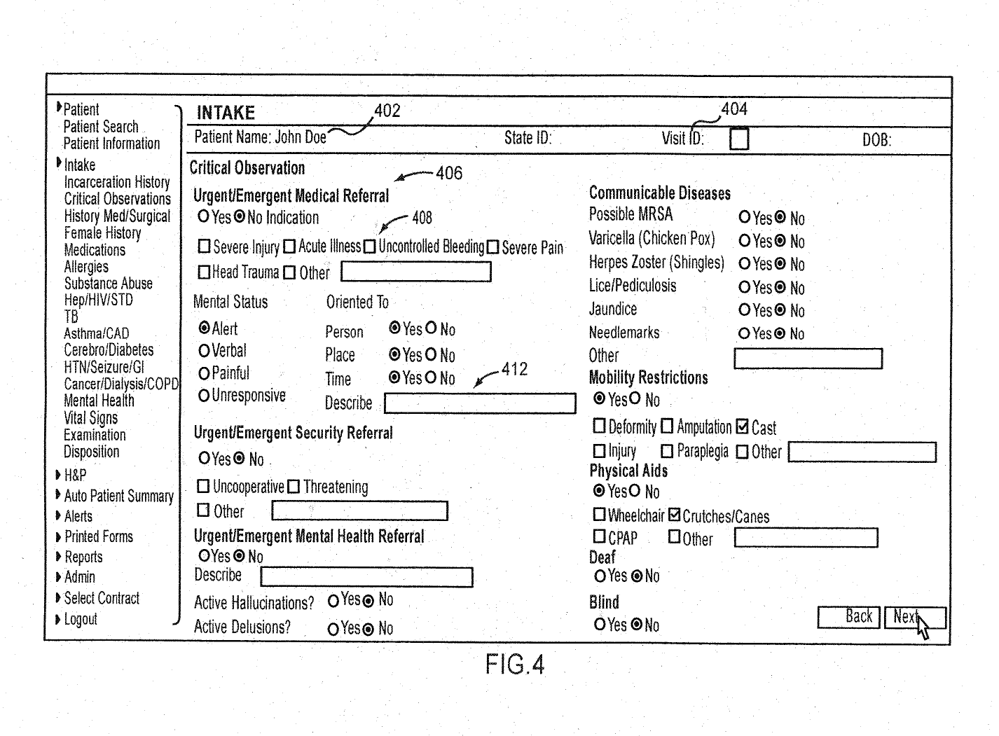

The intake and screening process 308 is presented in more detail in FIG. 4, in accordance with an aspect of the present invention. Individual 402 may be assessed for immediate health concerns, chronic conditions, infectious diseases, mental illnesses, or any issues that may harm individual 402 or others. If individual 402 needs medical attention, the intake screening process may be stopped and individual 402 can be given the appropriate medical treatment. The intake process may be completed after individual 402 has received the appropriate medical treatment. If individual 402 does not need immediate medical attention, the intake process may continue.

During the initial intake and screening process, categories of intake may be conducted for individual 402 including critical observations, history, mental health, vital signs, examinations and dispositions, among others. Critical Observations questions may be used to identify urgent or emergent medical needs. The History section questions may be used to get a basic healthcare history including any recent hospitalizations, allergies, current prescriptive medications, substance abuse, communicable diseases, and chronic illnesses, among others. A Mental Health section includes questions regarding the patient's mental status. The Vital Signs section records information including blood pressure, respiration, height and weight, among others. An Examination section records general appearance, oral cavity, and skin observations. The Disposition section may contain recommendation for placement in the jail or prison, confirmation that policies were reviewed, and referral information, among others.

Referring now to FIG. 4, individual 402 may have a Visit ID 404 which uniquely identifies individual 402 and allows information relating to individual 402 to be located and associated with individual 402. Visit ID 404 may be, for example, a booking number or a prison number, among others. Specific data in response to questions asked during the initial intake may be inputted into a data repository.

In general, every question in the intake process should have an answer. But if the questions 406 do not apply to individual 402, answer blocks 408 may be grayed out so the user does not need to enter answers in response to those questions. However, if the questions do apply to individual 402, additional questions may be asked based upon the responses provided by individual 402. For example, if individual 402 indicates the individual has mental health issues, additional questions may be asked regarding whether they have hallucinations or other delusions, among others. Additionally, individual 402 may be expedited for further mental health consultations based upon the response to the initial and/or additional questions.

Further, in an aspect of the present invention, the questions may require specific answers. The answers may include a drop-down list providing a list of available answers, yes or no buttons 410, or the user may need to enter the answer in the required field 412. It should be appreciated that the questions may be varied based upon individual 402. For example, there may be different questions depending on whether individual 402 is a male, female or juvenile, among others.

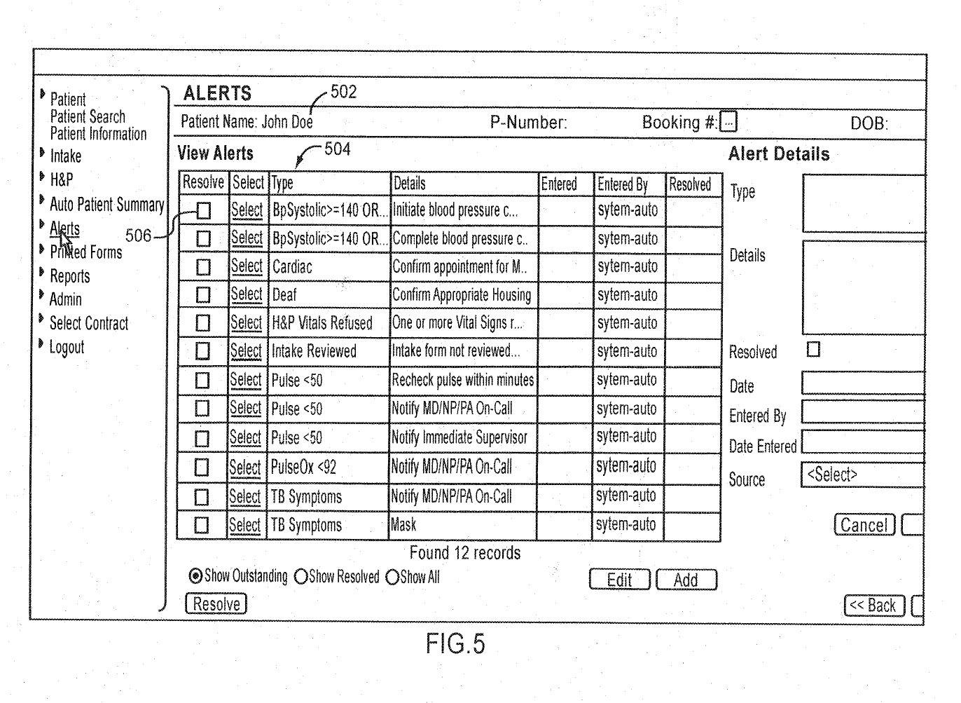

Further, in an aspect of the present invention it may be possible to automatically create triggers based upon the specific data entered to generate alerts for follow up activities for individual 402. For example, if individual 402 indicates a diabetes diagnosis, the system may automatically trigger an alert for an expedited specialized follow up instead of a routine follow up. Alternatively, the user may manually enter the alert for an expedited specialized follow up. Other pre-defined triggers may include the ability of the system to automatically add a lab or image alert, automatically add an appointment, and automatically add printed forms, among others. It should be appreciated that the user may add the pre-defined triggers for the alerts as well. The alerts, according to an aspect of the present invention, are presented in more detail in FIG. 5.

Referring now to FIG. 5, after the initial intake and screening process is completed, alerts 504 for clinically significant events may be created based upon data entered during the initial intake and screening process. In an aspect of the present invention, alerts 504 may be created automatically based upon a pre-defined trigger, may be created by the system user through a pre-defined trigger, or may be otherwise entered. In an aspect of the present invention, the alerts may include additional medical procedures, laboratory testing and imaging, follow up appointments, prescribing medication to individual 502, or calling a physician for immediate assistance, among others. Alerts 504 may ensure consistent follow up activities and may help guide a physician through a clinical exam.

In an aspect of the present invention, the list of alerts 504 may be sorted by clicking on the column headings above each column. For example, alerts 504 may be sorted by type, details, date the alert was entered and how the alert was entered, among others. Once an alert has been resolved by the user, the user checks or otherwise clears resolved box 506.

After completion of the initial intake process and screening, a history and physical exam may be conducted. The history and physical exam at most sites may be completed 7 to 14 days after the initial intake screening process. In an aspect of the present invention, a new history and physical can be created or an existing history and physical may be viewed after selecting an individual. It should be appreciated that the history and physical exam may be conducted by a different entity than the initial intake process and screening.

The history portion of the exam, for example, may contain two categories: medical/surgical and mental. The medical and surgical section may include, but is not limited to, recent hospitalizations, female history, current prescriptive medications, tobacco, substance abuse, communicable diseases, and chronic illnesses. The mental health section may ask a variety of mental health questions.

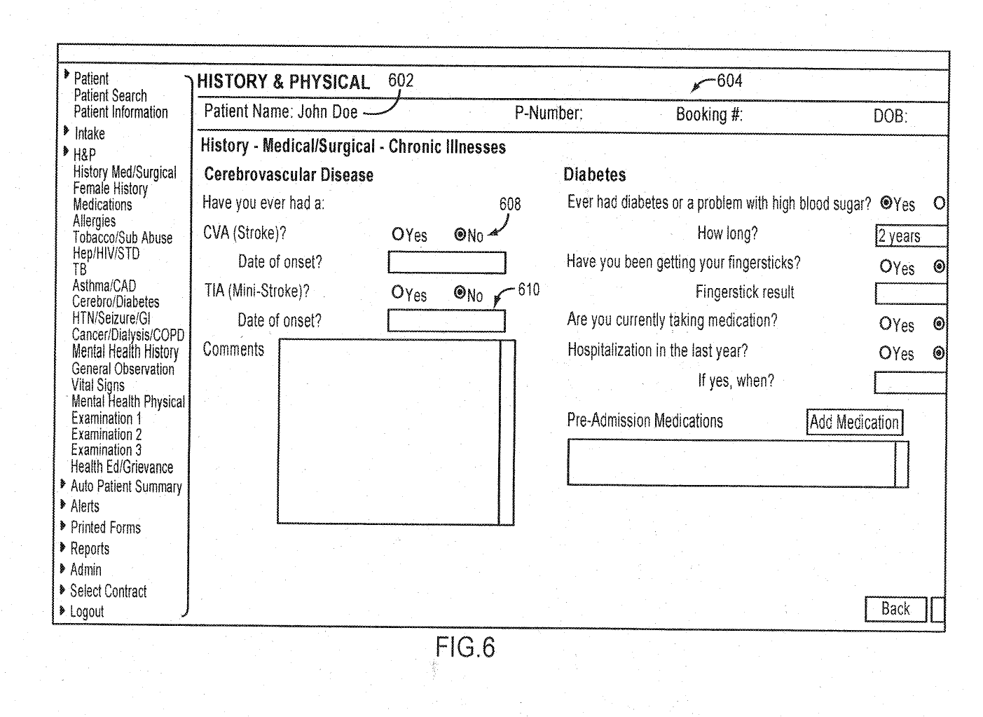

In the Physical portion of the history and physical, there may be the following subsections: General Observation, Vital Signs, Mental Health, Examination, Health Education, Grievance Process, Additional Comments, and Signature, among others. The General Observation subsection can contain, for example, questions about mobility restrictions, physical aids, and the senses. A Vital Signs subsection can include, but is not limited to, information about blood pressure, respiration, height and weight. In the Mental Health subsection there can be questions about mental status. Examination subsection contains physical examination questions about major body systems, among others. The Health Education subsection may include provided health related educational material. A Grievance Process subsection may be included to ensure that the grievance process has been explained to the patient. An Additional Comments subsection may be provided for recording any additional comments. Finally, in the Signature subsection the patient agrees to medical assistance and the person performing the history and physical signs. In an aspect of the present invention, the signature subsection may be done by recording the user id of the person performing the history and physical and printing a form at a later time to get the individual's signature. The history and physical exam is presented in more detail in FIG. 6.

Referring now to FIG. 6, the individual 602 may be asked more in depth questions regarding their medical history and family medical history. Every question asked during the history and physical examination should have an answer. However, if the questions do not apply to individual 602, the answers may be grayed out so the user does not need to enter responses to those questions. Further, the questions may be directed to specific answers. It should be appreciated the questions can be varied for various individuals. For example, different questions may be asked to males, females and juveniles, among others. The answers may include drop-down lists providing the available responses, selecting either yes or no buttons 608 or the user may need to enter in a value in the appropriate field 610. In addition, it may be possible to create triggers based upon the specific data entered to generate alerts for follow up activities. These alerts may ensure consistent follow up activities.

Further, in an aspect of the present invention it may be possible to automatically create triggers based upon the specific data entered to generate alerts for follow up activities for individual 602. Other pre-defined triggers may include the ability for the system to automatically add a lab or image alert, automatically add an appointment, and automatically add printed forms, among others. It should be appreciated that the user may add the pre-defined triggers for the alerts as well. The alerts according to an aspect of the present invention are presented in more detail in FIG. 5.

It will be understood by those of ordinary skill in the art, that for previously incarcerated individuals, the initial intake and screening process will have been completed, and subsequent routine and/or scheduled physicals/exams may be conducted by following steps 320-330.

Referring now to FIG. 5, in an aspect of the present invention, after the completion of the history and physical examination, alerts 504 for clinically significant events may be created based upon data entered during the history and physical examination. It should be appreciated that alerts 504 may be created automatically based upon a pre-defined trigger or may be created by the system user through a pre-defined trigger, or otherwise entered by the user. In an aspect of the present invention, the alerts may include additional medical procedures, laboratory testing and imaging, follow up appointments, prescribing medications to individual 502, or calling a physician for immediate assistance, among others. Alerts 504 may ensure consistent follow up activities and may help guide a physician through a clinical exam.

In an aspect of the present invention, the list of alerts 504 may be sorted by clicking on the column headings above each column. For example, alerts 504 may be sorted by type, details, date the alert was entered and how the alert was entered by, among others. Once an alert has been resolved by the user, the user may check or otherwise clear the resolved box 506.

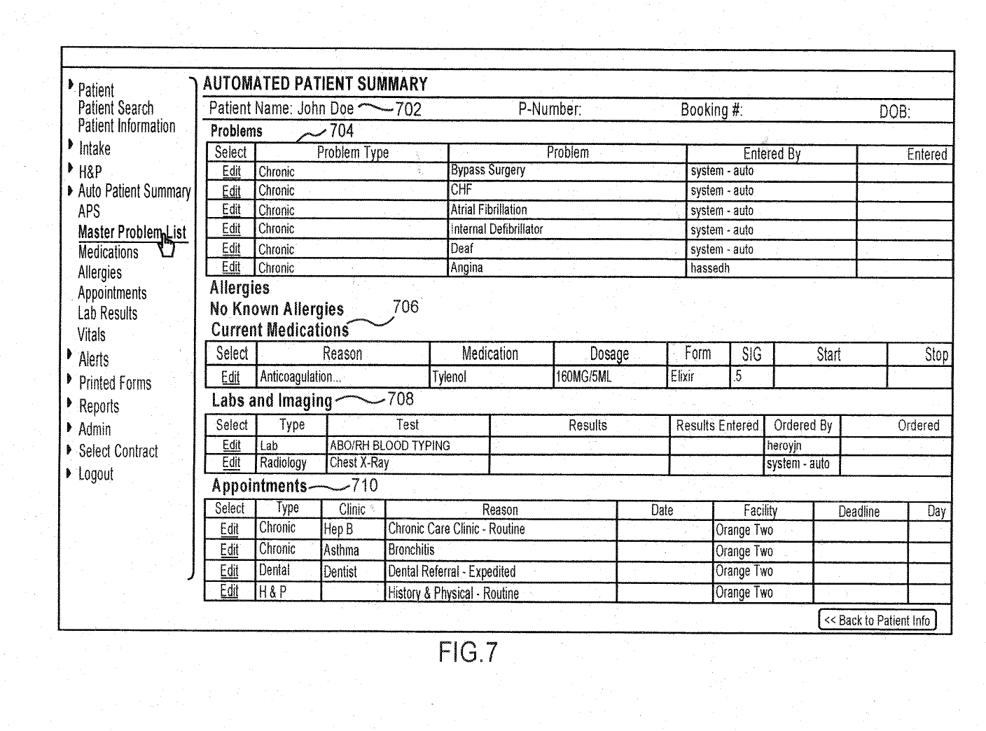

An aspect of the present invention may include a comprehensive medical history and/or diagnosis for the individual after the initial intake and screening process and history and physical examination are completed. For example, an automatic patient summary may provide comprehensive information regarding the individual in a central location. An automated patient summary according to an aspect of the present invention are presented in more detail in FIG. 7.

Referring now to FIG. 7, the automated patient summary report may include but is not limited to, a master problem list 704, allergies 706, labs and imaging 708, upcoming appointments 710, and current medications, among others. The automated patient summary may be accessible after choosing individual 702 and the completion of the initial intake and screening process. Each list may allow the user to go directly to the information contained in the list. For example, a user can click on a medication in the medications list and go to the medications screen with the selected medication's detailed information.

The master problem list 704 for individual 702 may record medical problems gathered during and after the initial intake and screening process or the history and physical examination and/or other physical examination, as applicable. Individual 702 and an intake screening or history and physical may be selected to access the problem list 704. Problem list 704 may include a list of problems and provide capability to see a detailed problem view and add new problems. Additionally, problems may be automatically or manually added through the use of a pre-defined trigger. It should further be appreciated that lab test, images, appointments, and medications can be associated with a problem. This association may be performed manually or automatic. The user may mark problems as resolved or otherwise clear the problem upon resolution of the problem.

In an aspect of the present invention, the allergies portion 706 may track allergies identified during the initial intake and screening process and/or the history and physical examination. An emphasis may be placed on life threatening allergies and significant medication allergies. Allergies can be identified by the type of allergy, for example, medication or environmental, among others. Additionally, the reaction that occurs for this allergy may be noted along with information on the allergy itself, for example, allergic to mold, may be recorded. Allergies 706 are tied to individual 702, therefore, individual 702 and an intake screening or history and physical can be selected to access allergy information for individual 702.

Additionally, allergies 706 can be marked as inaccurate to indicate that an allergy was entered in error. However, an allergy cannot be deleted or removed. There may be a predefined list of allergies from which the user can select. In addition, the user may select “other,” usually the last option, and enter any non-listed allergy. Further, the user may add additional comments. In an aspect of the present invention, a user may generate a report showing all medication allergies for a patient. A report may show, for example, all individuals currently at the site who have had an anaphylactic reaction to a medication or environmental allergen. It should be appreciated that this report may be modified to show a user-specified medication or environmental allergen.

In an aspect of the present invention, the labs and imagining 708 may record any labs and images ordered during the initial intake and screening process or the history and physical examination. The results of the labs once complete may be manually entered or may be sent in digital form from the lab. In order to view, add, or modify labs and imaging information the user may select an individual 702. Information that may be requested for each lab or image includes: the type (lab or radiology); the name of the test; results of the test; and data on who ordered the test and when, among others. It should be appreciated that there may be a general list of labs and images that have been ordered and the details of a particular lab or image may be accessed from the list. Additionally, an appointment may be added from the detailed view. Other functions in the detailed view may include the ability to indicate that a lab or image was not required, or was refused by the patient. Further, new labs and image orders can be added from a list in the system of labs and images.

Another aspect of the present invention may include any appointments 710 scheduled during the initial intake and screening process or the history and physical examination. In addition, sick calls and chronic care follow-ups after intake can be scheduled. Scheduling may be accessed from either the patient information screen or the intake history screen. In order to retrieve scheduling information, individual 702 may be selected. It should be appreciated that there may be a list of appointments that have been scheduled for individual 702 from which the user can choose an appointment 710 and see a detailed view. The detailed view may allow the user to update or add information such as: disposition of the appointment (i.e. pending, seen, rescheduled, etc.); designate an appointment as critical; and reschedule the appointment, among others. Further, new appointments may be added from the appointment list. Appointments may also be automatically or manually added by the system using a pre-defined trigger.

An aspect of the present invention may include any current medications at the time of the initial intake screening and process or the history and physical examination. In addition, prescribed medications after the initial intake or the history and physical examination may be recorded. Medications can be accessed from within the patient record. Individual 702 and intake should be selected to retrieve medication information. Historical medication functionality can include, among others, a list of the medications, medications associated with a condition, and ability to add new medications. Prescription medication functionality may have a list of prescription medications along with a detailed view of a single medication. In addition, it should be appreciated that capability may be provided to view medication allergies, add a new medication, and mark a medication as no longer active.

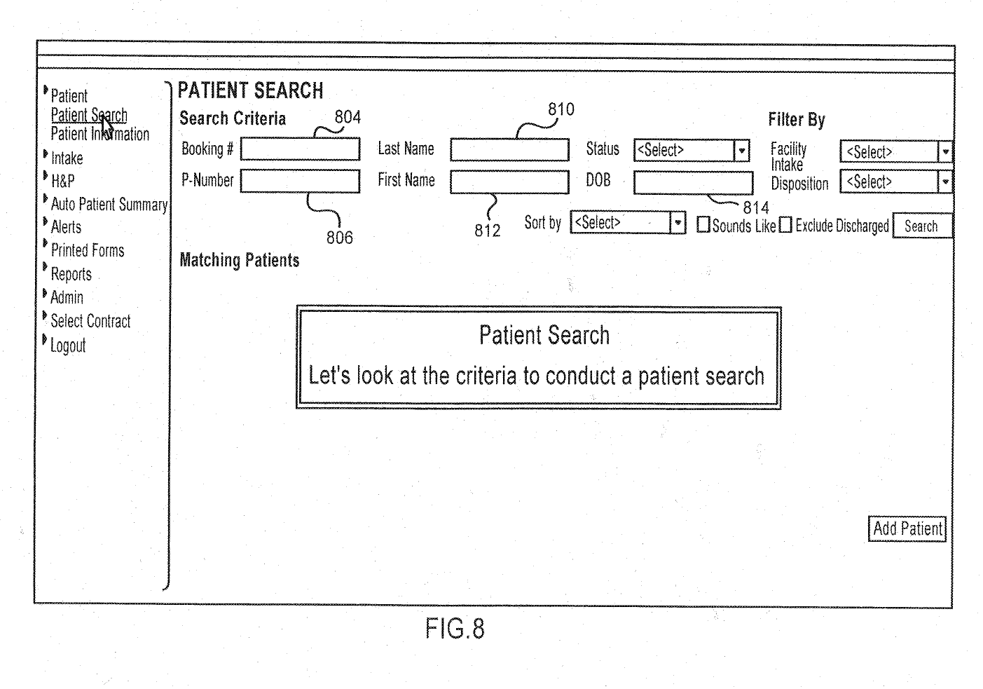

FIG. 8 presents in more detail aspects of the present invention allowing the user to identify and search for an individual. The patient identification and search functionality can allow each individual to be uniquely identified and found through the use of one or more identification numbers. For example, the identification numbers may include state id number, booking number 804, prison numbers 806, and visit identification numbers, among others. In addition, individuals that have previously been at the same facility should be identified by the same identification number so that previous information can be accessed. Further, a history of changes to demographic information and multiple arrest information can also be stored in the database. Once data has been imported, a person can be found by searching on first 812 and last name 810 or one of the unique identifiers.

Additional aspects of the present invention may provide the ability for the user to view and print reports with parameters they specify based on the specific data captured during the initial intake and screening process and the history and physical exam. Further, the user may select a printed form from a list of forms that were added during the initial intake and screening process or the history and physical exam.

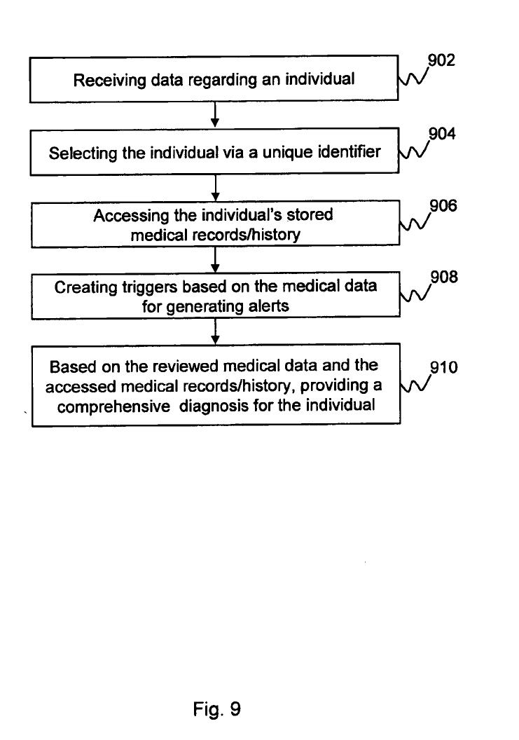

In one aspect of the present invention, an individual's stored medical records/history may be accessed in emergency or follow-up care involving the individual, as shown, for example, in FIG. 9.

The user may receive medical data regarding an individual 902. For example, the user may select an individual via a unique identifier 904 and/or the user may access the individual's stored medical records/history 906. It may be possible to create triggers based on the medical data for generating alerts 908. These alerts may ensure consistent follow-up activities and may help guide the healthcare personnel through follow-up activities involving the individual. Further, a comprehensive diagnosis for the individual may be provided based upon the received medical data and the accessed medical records/history 910. The comprehensive diagnosis may include a problem list, allergies, upcoming appointments, and current medications, among others.

It should be appreciated that aspects of the present invention may be used for follow up activities while preserving the individual confidentiality. The specific data captured during the initial intake and screening process and the history and physical exam may be extracted to preserve the individual's confidentially and complied to generate reports or studies on the data. For example, studies may be conducted on illnesses effecting different regions of the country, illnesses effecting different populations of individuals, comparing how an illnesses effects a population in one area of country versus another area of the country, among others.

Further, it should be appreciated that aspects of the present may be used in helping to facilitate an individual's reentry into the community. For example, once an individual leaves a correctional facility, they may need continuing medical treatments. Aspects of the present invention may facilitate health information exchange with federal governments, local governments, or health providers, among others.

Aspects of the present invention provide benefits and advantages that include the ability to capture the current health state of an individual in a central location making the information readily available clinicians, either on-site or off-site of the correctional facility.

Further, the present invention allows for consistent medical treatment by asking the same detailed questions which generate the same alerts for follow up treatments. In addition, the present invention provides risk management by ensuring the proper medical treatment is given to the individual by using pre-defined triggers to generate alerts based on specific data captured. Also, the present invention provides comprehensive diagnosis of an individual as opposed to encounter diagnosis.

Additionally, the present invention allows for flexibility. The present invention may be used in state or federal correctional facilities. For example, the present invention may be used in prisons or jails, among others. The present invention may be modified to follow state specific issues including but not limited to, laws, rules, procedures, or recommendations. Further, as the law involving correctional health care changes, the system can easily be updated and modified to incorporate those changes. Moreover, the present invention can be used for various contracts with correctional facilities having different requirements, rules, or procedures, among others for health care treatments.

Further, it will be appreciated by those of ordinary skill in the art, that the present invention may be implemented in a single facility, or may be shared among several facilities.

Example aspects of the present invention have now been described in accordance with the above advantages. It will be appreciated that these examples are merely illustrative of the invention. Many variations and modifications will be apparent to those skilled in the art

Moreover, while numerous aspects of the system and method of the present invention have been described in relation to providing health care services for incarcerated individuals, it is within the scope of the present invention to apply the system and method of the present invention with any medical procedure, particularly new medical treatments that are not widely practiced for the reasons explained above. Other aspects will be apparent to those skilled in the art form a consideration of the specification or from a practice of the invention disclosed herein It is intended that the specification and the described examples are considered exemplary only, with the true scope of the invention indicated by the following claims.

What is claimed is:

1. A method for providing health care services, the method comprising:
receiving medical data regarding an individual;
storing the received medical data in a data repository;
creating triggers based on the medical data for generating alerts; and
generating a report based on the received medical data and the created triggers.

2. The method of claim 1, further comprising:
accessing the individuals stored medical data.

3. The method of claim 1, further comprising:
generating a report based on a comprehensive diagnosis.

4. The method of claim 3, wherein the generated report based on the comprehensive diagnosis includes one of a problem list, a list of allergies, a list of upcoming appointments, a list of labs, a list of imaging, and a list of current medications.

5. The method of claim 1, wherein the alerts include one selected from a group consisting of: additional medical follow-up procedures, labs, imaging, follow-up appointments, and prescribing medication to the individual.

6. The method of claim 1, wherein the created triggers are pre-defined.

7. The method of claim 1, wherein the created triggers are automatically entered.

8. A method of claim 1, wherein the created triggers are inputted by a user.

9. A system for providing health care services, the system comprising:
a module for receiving medical data regarding an individual;
a module for storing the received medical data in a data repository;
a module for creating triggers based on the medical data for generating alerts; and
a module for generating a report based on the received medical data and the created triggers.

10. The system of claim 9, further comprising:
a module for accessing the individuals stored medical data.

11. The system of claim 9, further comprising:
a module for generating a report based on a comprehensive diagnosis.

12. The system of claim 11, wherein the generated report based on the comprehensive diagnosis includes one of a problem list, a list of allergies, a list of upcoming appointments, a list of labs, a list of imaging, and a list of current medications.

13. The system of claim 9, wherein the alerts include one selected from a group consisting of: additional medical follow-up procedures, labs, imaging, follow-up appointments, and prescribing medication to the individual.

14. The system of claim 9, wherein the created triggers are pre-defined.

15. The system of claim 9, wherein the created triggers are automatically entered.

16. A system of claim 9, wherein the created triggers are inputted by a user.

17. A system for providing health care services, the system comprising:
a processor;
a user interface functioning via the processor; and
a repository accessible by the processor;
wherein an initial intake of medical information is performed on an individual;
wherein a first specific data is inputted regarding the medical information;
wherein an examination is performed on the individual;
wherein a second specific data is inputted regarding the examination;
wherein a comprehensive diagnosis is provided for the individual; and
wherein triggers are created based on the second specific data for generating alerts.

18. The system of claim 17, wherein the processor is housed on a server.

19. The system of claim 18, wherein the server is coupled to a network.

20. The system of claim 19, wherein the coupling is selected from a group consisting of a wired connection, a wireless connection, and a fiberoptic connection.

21. The system of claim 17, wherein the repository is housed on a server.

22. The system of claim 21, wherein the server is coupled to a network.

23. A computer program product comprising a computer usable medium having control logic stored therein for causing a computer to provide health care services, the control logic comprising:
first computer readable program code means for receiving medical data regarding an individual;
second computer readable program code means for storing the received medical data in a data repository;
third computer readable program code means for creating triggers based on the medical data; and
fourth computer readable program code means for generating a report based on the received medical data and the created triggers.
